(19) United States
(12) Patent Application Publication
(10) Pub. No.: US 2009/0015842 A1
(43) Pub. Date: Jan. 15, 2009

(54) Phase Sensitive Fourier Domain Optical Coherence Tomography

(76) Inventors: Rainer Leitgeb, Ecublens (CH); Adrian Bachmann, Tobel (CH); Theo Lasser, Echandens-Denges (CH)

Correspondence Address: NIXON & VANDERHYE, PC, 901 NORTH GLEBE ROAD, 11TH FLOOR, ARLINGTON, VA, 22203, US

(21) Appl. No.: 11/886,592

(22) PCT Filed: Mar. 21, 2005
(86) PCT No.: PCT/IB2005/050958

§ 371 Date: May 28, 2008

(51) Int. Cl. G01B 9/02

(52) U.S. Cl. 356/456

(57) ABSTRACT

Optical Coherence Tomography (OCT) is an imaging technique with high axial resolution in the micro-meter-scale range combined with a high sensitivity allowing for example to probe weakly back-scattering structures beneath the surface of biological tissues up to several millimeters. A major improvement of this conventional technique represents Fourier Domain OCT with a further decrease in image acquisition time and additional sensitivity. The apparatus including appropriate signal processing reconstructs the depth profile from the spectrally resolved light signal generated by a broadband source and an interferometric imaging system. By frequency shifting the light fields with frequency shifting means in the reference and sample arm a phase resolved signal at high speed can be registered. Therefore the reference arm does not rely on arm length changes or delays. The beating signal generated in this way shows high phase stability. The phase of this beating signal is not wavelength dependent, as the frequency shift applied is the same for all wavelengths. Moreover this results in an additional suppression of unwanted auto-correlated distortion as well as an extended depth range.

### FIELD OF THE INVENTION

The invention relates to imaging systems and more particularly to tomographic and interferometric imaging systems with phase resolution.

### BACKGROUND OF THE RELATED ART

Optical Coherence Tomography (OCT) is a non-contact imaging modality based on the coherence properties of light. This optical tomography developed due to its steady progress over the last two decades from the initial proposal into a diagnostic tool for medicine as well as an imaging modality for biological applications.

OCT is an interferometric imaging technique that allows for high-resolution, cross-sectional imaging of biological tissue. In the standard time-domain (TD) implementation of OCT, a low-coherent light from a broadband source is divided into the reference path and into the sample path. The interference pattern as a result of the superposition of back-reflected light from the sample as well as the reference path contains information about the scattering amplitude as well as the location of the scattering sites in the sample. In conventional Time Domain Optical Coherence Tomography (TDOCT) the position of the reference reflector in the interferometer is rapidly scanned in order to extract the scattering amplitude from the interference signal and to reconstruct a depth profile of the sample.

In TDOCT, the signal results from the interference between the back-scattered light field originating from the coherently illuminated sample and the reference field. This interference occurs only, if the optical path lengths of reference and sample beams coincide within the ‘coherence gate’, which is of the size of the so-called round trip coherence length, determined by the spectrum of the source. OCT therefore measures absolute distances. Detecting the envelope of this interferogram pattern allows measuring the sample reflectivity over depth, the so-called “A-scan” or depth profile. The tomographic information i.e. the cross-sectional images are synthesized from a series of laterally adjacent depth-scans. This two-dimensional map of reflectivity over depth and lateral extent is the so-called “B-scan” or tomogram. The axial resolution in OCT is given by the width of the ‘coherence gate’, which is determined by the spectrum of the used broadband source. The transversal resolution of the OCT tomogram is determined by the resolution properties of the sample arm optics, which is usually given by numerical aperture of the used focusing system of the scanning optics.

Conventional time-domain OCT is a single-point detection technique. Such an instrument can be designed to operate at moderate (1 B-scan/sec) and high acquisition speeds (close to video rate).

OCT imaging has been applied as a diagnostic tool in many medical applications. Imaging the anterior and posterior segment of the human eye is to date the most prominent medical application, however OCT applied in dermatology, gastroenterology, for optical biopsies as well as imaging in biology has been reported. Specialized probes, endoscopes, catheters and attachments to diagnostic and surgical microscopes have been designed to extend the field of applications for OCT imaging.

However, TDOCT has some important limitations. First, in TDOCT, the image acquisition rate is mainly limited by the technical requirements for the depth scan. This translates often into an increase of complexity for the scanning system with a decreasing reliability especially for OCT-systems with high acquisition speeds close or at video rates. Second, the serial signal acquisition in TDOCT during an A-scan is not very efficient. The sample is illuminated over the whole depth, whereas the signal results only from the backscattered field emanating from a limited volume limited by the ‘coherence-gate’. This limitation is particular important in opthalmology where the maximum power is limited due to safety reasons, particular in retina diagnosis. Third, the serial scanning in TDOCT demands that the sample under investigation remains stationary during the whole tomographic image acquisition time, otherwise motion artefacts may severely degrade the image quality.

A potential solution overcoming these limitations represents the so-called Fourier Domain Optical Coherence Tomography (FDOCT). As its counterpart TDOCT, FDOCT belongs also to low coherence interferometry. However in FDOCT, the reference arm has a pre-chosen but fixed arm-length during the image acquisition and the scattering amplitude over depth is derived from the optical spectrum of the detected light resulting from the back-reflected sample field mixed with the reference field. This light field is spectrally decomposed by a spectrometer and detected by an array detector such as a charge-coupled device (CCD), which allows the registration of the spectrally resolved information simultaneously. The registered spectrum encodes the complete depth profile. FDOCT does not need a serial depth scanning and records the full depth information in parallel. This allows a high-speed acquisition of depth profiles well above 10 kHz. Moreover, FDOCT shows increased sensitivity due to the so-called Fellgett advantage, in comparison to conventional TDOCT. If the detection is close to the shot noise limit, the FDOCT sensitivity is in fact independent of the optical bandwidth of the source. This is not the case for TDOCT. Since an increased optical bandwidth means also increased axial resolution, FDOCT is capable of performing ultrahigh resolution imaging at high data acquisition speeds.

The registered depth profile using FDOCT is related to the inverse Fourier transform of the acquired spectral data. Initial attempts and implementations of FDOCT suffered from several unwanted signal contributions resulting from:
1) Large DC-components on the array detector caused by non-interfering contributions from the sample and reference arm. These DC-components can be much larger than the interferometric signal contributions.
2) Autocorrelation contributions of light fields originating from different reflection sites within the sample under investigation.
3) Ambiguous sample structure information due to symmetry of the Fourier transform result with respect to the zero path length difference.
   These contributions degraded the image quality of the first FDOCT instruments. New implementations of FDOCT integrate techniques known from phase-shift interferometry, which allows suppressing the above-mentioned contributions. In these instruments multiple spectra with different phase shift, achieved by corresponding specific reference arm length changes, are acquired.

Phase shifting is a well-established and well-described concept in literature [1]. First a three-phase step concept and later a five-step concept for minimizing phase calibration errors were employed. Such methods allow reconstructing the complex sample field. As a result, the before mentioned structure ambiguity with respect to the zero path length difference is removed and the probing depth range is doubled. A two-step algorithm was introduced, resulting in a depth profile with suppressed DC and autocorrelation contributions, as well as with the advantage of depth range doubling. In this technique a path-length difference of λ/4 is introduced into the reference arm by moving a reflector mounted on a piezo-actuator. This results into an accumulated phase-shift of π/2. A complex signal can therefore be constructed by adding the shifted interference signal as quadrate term to the original, un-shifted signal.

A different phase-shifting method adding a total phase shift of π allows removing the autocorrelation contributions as well as the DC term. Nevertheless this method does not double the depth range. It can be viewed as a differential method since the phase shift caused by a change in reference arm length inverses the sign of the interferometric cross-correlated contributions, whereas the DC-term as well as the autocorrelation contributions are not affected. The subtraction of two images, with a phase shift difference of π, results in a calculated structure that is free of non-interfering contributions from the sample and reference arm (DC-contribution) and auto-correlation contributions.

The Fourier transform of the recorded spectrum is a complex-valued function. The absolute value yields information about refractive index gradients in the sample whereas the argument gives access to structural changes with sub-wavelength precision. Phase-resolved axial structural changes with a precision of 4 nm have been reported. It was shown that in taking the phase difference between at least two adjacent depth profiles, the flow profiles in small retinal vessels could be extracted. The origin of the phase change itself can be manifold. Tracing slight spatial changes of the—in general complex—refractive index for example would enable phase contrast imaging. Sticker et al. showed the advantage of phase contrast imaging in the field of OCT. Whereas they used standard time domain OCT, FDOCT would offer the advantage of higher imaging speed as well as the intrinsic enhanced phase stability.

FDOCT signal evaluation gives also access to different optical sample properties such as absorption, dispersion and polarization. Such information provides insight into functional properties of tissues or cells, such as for example oxygenation, glucose content, concentration of metabolic agents or mineralization. In the case of polarization, a detection unit is needed that records separately the two orthogonal polarization states of the light at the exit of the interferometer.

If the sample is illuminated with a line instead of a scanning point, additional speed advantage is gained. The set of parallel detection points is analyzed by an imaging spectrograph, where the spectrum of each parallel channel is recorded individually on a two dimensional detector array. After inverse FFT of each spectrum a full tomogram is obtained with one detector recording.

FDOCT addresses several solutions to overcome technical as well as principle limitations of OCT systems. As indicated above, FDOCT provides a much faster depth scanning with improved sensitivity. Multi frame FDOCT additionally yields a suppression of DC- and the autocorrelation contribution by borrowing and applying concepts from phase-shifting interferometry. Additionally complex FDOCT allows doubling the achievable measurement range, and gives access to the complex sample field.

FDOCT addresses several solutions to overcome technical as well as principle limitations of OCT systems. As indicated above, FDOCT provides a much faster depth scanning with improved sensitivity, a suppression of DC- and the autocorrelation contribution by borrowing and applying concepts from phase-shift interferometry. However existing limitations within this prior art FDOCT exist and include:
1) wavelength dependent phase shifts
2) limited axial resolution due to wavelength dependant phase shifts
3) reduced phase stability due to mechanical arm length changes
4) limited image acquisition rate due to arm length changes based on arm length movements
   This invention allows also additional measuring possibilities including, but in no case limited to:
5) polarization
6) absorption
7) spectroscopic properties
8) differential phase
9) dispersion
10) functional parameters as blood flow, tissue properties etc.

### SUMMARY OF THE INVENTION

An object of this invention is to propose at least solutions for the mentioned problems and/or disadvantages and to provide at least solutions and/or advantages hereinafter.

Another object of this invention is a high-speed phase-resolved FDOCT method consisting in a freely chosen but fixed frequency shift [2] of the light fields in each interferometer arm, resulting in a frequency difference, the so-called beating signal, where the clock frequency of the read-out cycle of the array detector is matched to the frequency or a multiple of this frequency difference of this beating frequency.

A further object of this invention is a high-speed phase-resolved FDOCT method without mechanically moving parts providing a high stability during signal acquisition.

Another object of this invention is to build a FDOCT system including frequency shifting means and achieving a wavelength independent phase sensitive FDOCT system.

A further object of this invention is to use a detector suitable for detecting, filtering and isolating a characteristics (typically amplitude and/or phase) of the oscillatory component of the time dependent beating signal.

A further object of this invention is to build a FDOCT system with high axial resolution by using a very broad-band source and achieving a wavelength independent, phase sensitive FDOCT system.

An object of this invention is to acquire n spectra at n fixed phase-points for calculating the phase signal.

An object of this invention is a twofold increased depth range of FDOCT dependent on the spectrometer resolution and detector size (number of pixel). This phase-sensitive FDOCT provides a two time increased depth range of

$${l}_{max} = \frac{1}{2 n} \frac{{λ}_{0}^{2}}{Δ {λ}_{Spec}} N , {l}_{max} = 2 \cdot {l}_{max}^{class} ,$$

with n as the refractive index, λ₀ as the central wavelength of the detected spectrum, Δλ_{spec} as the spectrometer bandwidth and N the number of illuminated pixels (supposing a Gaussian spectrum).

An object of this invention is to do frequency shifting in order to generate a wavelength independent beating signal at the detector.

An object of this invention is an interferometer were the interference fields are described as

I^{k}=I_{DC}^{k}+Iᵢₙₜ^{k}=I_{R}^{k}+I_{S}^{k}+E_{R}^{k}E_{S}^{k}*+E_{R}^{k}*E_{S}^{k}.

I_{R,S}^{k} denote the reference and sample light intensities in the k-space with E_{R}^{k} and E_{S}^{k} as the reference and sample light fields and E_{R}^{k}* and E_{S}^{k}* as their complex conjugate. The two light fields E_{R}^{k} and E_{S}^{k} can be written as

$${E}_{R}^{k} ( {ω}_{R}^{′} , t ) = \sqrt{{I}_{R}^{k}} {e}^{j ( {k}_{R} {z}_{R} - ( {ω}_{0} + Δ {ω}_{R} ) t - {ϕ}_{R} )} , \\ {E}_{S}^{k} ( {ω}_{S}^{′} , t ) = \sqrt{{I}_{S}^{k}} {e}^{j ( {k}_{S} {z}_{S} - ( {ω}_{0} + Δ {ω}_{S} ) t - {ϕ}_{S} )} , \\ {ω}_{R}^{′} = {ω}_{0} + Δ {ω}_{R} , \\ {ω}_{S}^{′} = {ω}_{0} + Δ {ω}_{S} ,$$

with

$$\sqrt{{I}_{R , S}^{k}}$$

as the field amplitudes, k_{R,S} the wave numbers and ω′_{R,S} the frequency of the reference and the sample light fields after respective frequency shifting, z_{R,S} the total reference and sample arm length and φ_{R.S} arbitrary initial phases. The resulting interference contribution is

$${I}_{int}^{k} ( t ) = 2 \sqrt{{I}_{R}^{k}} \sqrt{{I}_{S}^{k}} cos ( Ω t - Ψ ) ,$$

with Ω=|Δω_{R}−Δω_{S}| as the beat signal frequency and Ψ containing all time-independent phase terms. This time dependent signal is not wavelength dependent as the frequency shifting means apply the same frequency shift to all light frequencies.

An object of this invention is to perform two spectral measurements at a π/2 phase difference, which are sufficient for composing the complex spectrum signal in k-space, resulting in

$${I}_{int}^{\% k} = {I}_{int}^{k} ( t = 0 ) + {iI}_{int}^{k} ( t = \frac{π / 2}{Ω} ) .$$

The complex signal including DC-terms therefore becomes

$${I}_{int}^{\% k} = {I}_{DC}^{k} + {iI}_{DC}^{k} + {I}_{int}^{k} ( t = 0 ) + {iI}_{int}^{k} ( t = \frac{π / 2}{Ω} ) .$$

An object of this invention is the efficient suppression of DC- and autocorrelation contributions. These contributions are not varying with the beat signal. They are efficiently suppressed by calculating a term ΔS⁺ according to

$$Δ {S}^{+} = {[ \vert F \{ {I}^{\% k} \} \vert - \vert F \{ {I}^{\% {k}^{*}} \} \vert ]}^{+} ,$$

where F{g} is the Fourier transform, [symbol] is the complex conjugate valued signal of [symbol] and [g]⁺ stands for only positive signal terms. This is a simple algorithm but not the only possible one and therefore should not limit the scope of this invention.

An object of this invention is the extraction of the phase difference or the differential phase value between successive depth profiles

$$Δ Φ ( z ) = {F}_{Φ} \{ {I}_{int}^{k} ( t = 0 ) \} - {F}_{Φ} \{ {I}_{int}^{k} ( t = \frac{δφ}{Ω} ) \} - δϕ ,$$

allowing to access structural changes as well as changes in optical length with sub-wavelength resolution (δφ accounts for phase changes during the detection sequence).

An object of this invention is phase contrast FDOCT imaging that uses the depth resolved phase information to trace small refractive index changes in at least one transverse direction. For this task the phase difference at each depth position between two depth profiles is calculated.

An object of this invention is the integration and translation of these algorithms, but not limited to these specifically shown algorithms, in hardware configuration for signal processing.

An object of this invention is a high-speed phase-resolved FDOCT method for detecting phase-related parameters as flow, blood flow, cell movements, cell motions or any changes in geometrical dimensions or changes in the complex index of reflection which translates to a change in the phase signal.

An object of this invention is a FDOCT method allowing to measure only the autocorrelation contribution resulting from interactions in the reference arm, or to measure only the autocorrelation contribution resulting from interactions in the sample arm, including light sample interactions, or the cross-correlation between both arms, by an appropriate synchronisation of the clock frequency of the detectors to the specific beat frequencies. A configuration, where only the interactions in the sample arm are measured, can also be seen as a common-path interferometer as described in the embodiment description of FIG. 4.

An object of this invention is a FDOCT method allowing measuring the sample simultaneously at a plurality of transverse positions. This means that the region of illumination consisting of any distribution of illumination points on the sample is converted preferably by a fiber bundle into a one dimensional distribution matched to the entrance port of the spectrometer.

An object of this invention is a high-speed phase-resolved FDOCT method performing so-called Doppler measurements which can be used in a multitude of biological applications like, but not limited herewith, opthalmology and dermatology.

Additional advantages, objects and features of the invention will be set forth in part in the description and claims which follow and in part will become evident to those having ordinary skill in the art upon examination of the following or may learned from practice of the invention. The objects and advantages of the invention may be realized and attained as particularly pointed out in the appended claims.

### BRIEF DESCRIPTION OF THE DRAWINGS

The invention will be described in detail with reference to the following illustrations in which like reference numerals correspond to like elements wherein:

FIG. 1A is a general illustration of a phase sensitive FDOCT system, in accordance and correspondence with the present invention;

FIG. 1B is a schematic illustration of a first embodiment of a phase sensitive FDOCT system, in accordance and correspondence with the present invention;

FIG. 1C is a schematic illustration of a second, fiberized embodiment of a phase sensitive FDOCT system, in accordance and correspondence with the present invention;

FIG. 1D is a schematic illustration of a third, fiberized and polarisation sensitive embodiment of a phase sensitive FDOCT system, in accordance and correspondence with the present invention;

FIG. 2A is a schematic illustration of a fourth embodiment of a phase sensitive FDOCT system, in accordance and correspondence with the present invention;

FIG. 2B is a schematic illustration of a fifth embodiment of a phase sensitive FDOCT system, in accordance and correspondence with the present invention, where the sample is investigated in transmission;

FIG. 2C is a schematic illustration of a sixth embodiment of a phase sensitive FDOCT system, in accordance and correspondence with the present invention;

FIG. 2D is a schematic illustration of a seventh, polarisation sensitive embodiment of a phase sensitive FDOCT system, in accordance and correspondence with the present invention;

FIG. 2E is a schematic illustration of an eighth, fiberized embodiment of a phase sensitive FDOCT system, in accordance and correspondence with the present invention;

FIG. 2F is a schematic illustration of a ninth, fiberized and polarisation sensitive embodiment of a phase sensitive FDOCT system, in accordance and correspondence with the present invention;

FIG. 3 is a schematic illustration of a tenth embodiment of a phase sensitive FDOCT system, in accordance and correspondence with the present invention;

FIG. 4 is a schematic illustration of a first embodiment of an “interferometric source”, in accordance and correspondence and in combination for use with the present invention;

FIG. 5 is a schematic illustration of a first synchronization unit, containing the trigger signal generation as a part of the synchronization unit, in accordance and correspondence with the present invention;

### DETAILED DESCRIPTION OF PREFERRED EMBODIMENTS

### I. Embodiments of Michelson Interferometer Type

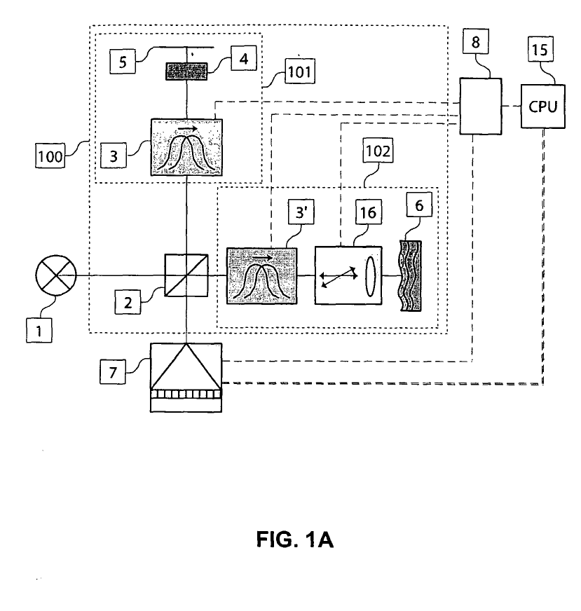

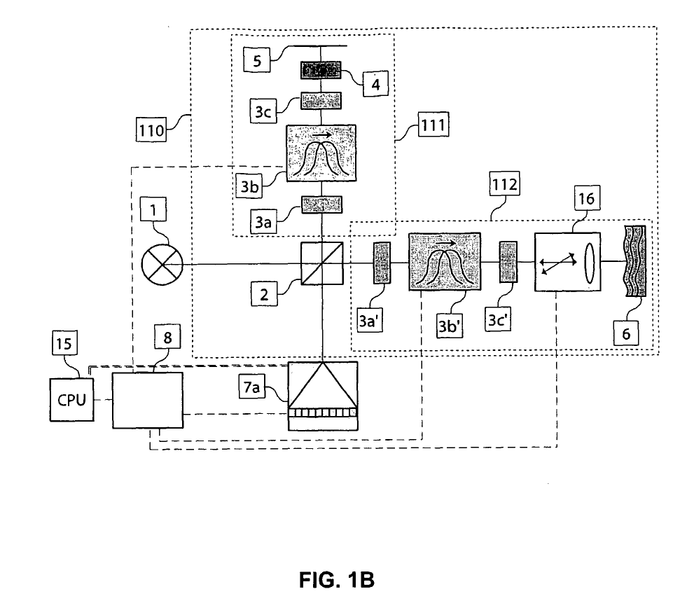

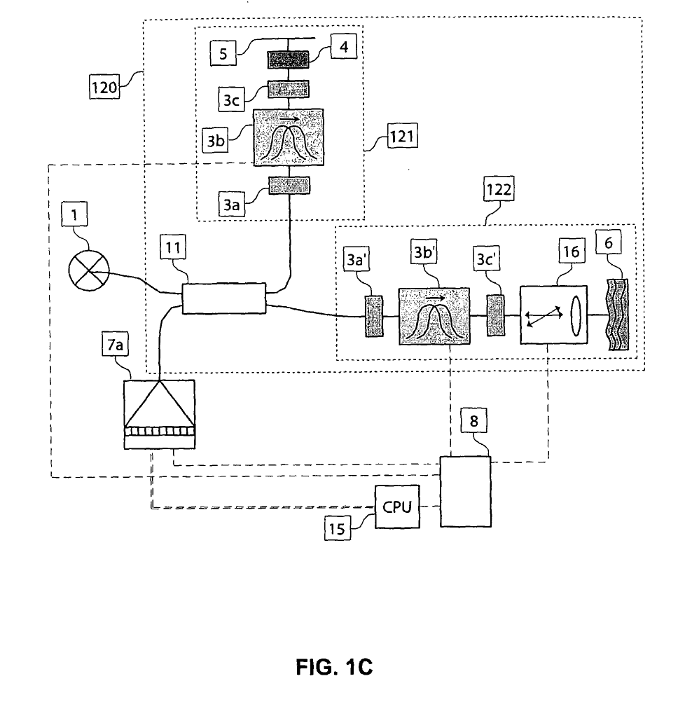

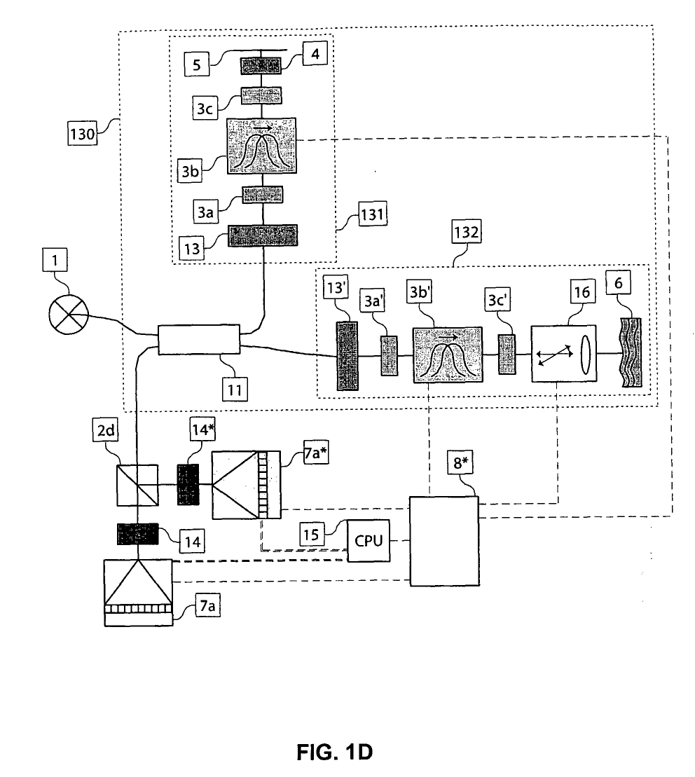

Referring to FIG. 1A, a general illustration of a phase sensitive FDOCT system, in accordance with the present invention, is shown. In this general illustration a scanning Michelson interferometer 100 is shown in combination with an appropriate spectrometer unit 7.

The FDOCT system including appropriate signal processing reconstructs the depth profile from the spectrally resolved light signal generated by a broadband source 1 and an interferometric imaging system 100.

Those of ordinary skill in the art will recognize the scanning imaging Michelson interferometer 100. Light from the broadband source 1 is divided and redirected by the beam dividing and recombining device 2 into the reference arm 101 and the sample arm 102. The light beam in the reference arm 101 is back reflected by the reflector 5 and mixed at the beam dividing and recombining device 2 with back-reflected light from the sample 6 containing weakly back-scattering structures. The reference arm length of reference arm 101 is fixed and not changed during the measurements. An optional optical mean 4 for dispersion compensation is placed in reference arm 101. This recombined light at the output port of the interferometer 100 is spectrally resolved and the light spectra are detected in the spectrometer unit 7, containing either a 1D-line or a 2D-array detector. The digitized spectra at the output port of the spectrometer unit are transferred to the central processing unit (CPU) 15.

By frequency shifting the light fields with frequency shifting means 3 and 3′ in the reference 101 and sample arm 102, a phase resolved signal at high speed can be registered.

An electronic synchronisation unit 8 links the driving signals of the frequency shifting means 3 and 3′, the clock signals of the detector in the spectrometer unit 7, the scanning optics 16 and the CPU 15, and allows to extract a beating signal with high phase stability.

Those of ordinary skills in the art will recognize that, although it is preferred to scan the sample 6 by scanning the light beam via a scanning mean 16, that moving the sample in an appropriate way across a stationary light beam may also scan the sample.

Referring to FIG. 1B, a first phase sensitive FDOCT system 1B in accordance with one possible embodiment of the present invention, is shown.

The FDOCT system 1B of FIG. 1B corresponds to a Michelson imaging interferometer setup 110 illuminated by a partially coherent broadband source 1. The light beam coming from the source 1 is split and redirected by the beam dividing and recombining device 2 into a reference 111 and a sample arm 112.

The reference arm 111 has a pre-chosen but fixed arm-length during the image acquisition time. The reference arm 111 contains a frequency shifting mean 3b combined with optional, appropriately chosen compensation optics 3a, 3c for optionally correcting undesired light field deviations or deformations caused by the frequency shifting mean 3b. A dispersion compensation mean 4 is placed somewhere in the reference arm 111.

The sample 6 can be displaced in one or two dimensions x or x-y on a scanning table 16 for scanning the sample or equivalently via a scanning optics 16, which is placed in front of the sample 6 and scans the sample beam over the sample 6. A frequency shifting mean 3b′ combined with optionally, appropriately chosen compensation optics 3a′, 3c′, driven at a different frequency as the frequency shifting mean 3b, is positioned in the sample arm 112 to provide an appropriate frequency shift of the sample light beam.

The beam dividing and recombining device 2 recombines the light fields back reflected from the reference 111 and the sample arm 112. The recombined light field propagates to the spectrometer unit 7, which contains optionally beam shaping, redirecting, separating and/or filtering optics. The recorded signal is data processed within or outside the spectrometer unit 7a. A synchronization unit 8 assures the synchronization between the frequency shifting mean 3b and 3b′ and the clock circuits of the detector in the spectrometer unit 7a. The electronic synchronization unit 8 links the driving signals of the frequency shifting means 3 and 3′, the clock signals of the detector in the spectrometer unit 7, the scanning optics 16 and the CPU 15 and allows to register the spectra at definite time points.

Referring to FIG. 1C, a second phase sensitive FDOCT system 1C in accordance with one possible embodiment of the present invention, is shown. The FDOCT system 1C of FIG. 1C corresponds to a fiberized version of a Michelson interferometer setup 120 illuminated by a partially coherent broadband source 1 in close resemblance to the first embodiment shown in FIG. 1B.

The light beam exiting from the source 1 is injected into a fiberized imaging Michelson interferometer setup 120. All or a part of these elements in this setup 120 are selected from the group of fiberized components.

As will be appreciated by those of ordinary skill in the art, there are several ways to realize the fiberized beam dividing and recombining device 11. This beam splitting component 11, which splits and redirects the light field into a reference 121 and a sample arm 122, can also be realized with so-called optical circulators, which may result in a setup with lower loss.

Frequency shifting means 3b and 3b′ are placed in the reference 121 and sample arm 122. The reference arm 121 may optionally include a dispersion compensation mean 4, which can be optionally realized by bulk optic elements. The back reflecting element 5 can be integrated in a fiber-optical element or realized via a bulk optic reflector with appropriate means for in- and out coupling into the fiber.

For elements not mentioned explicitly nor described in this embodiment description, please refer to previous embodiment descriptions.

Referring to FIG. 1D, a third phase sensitive FDOCT system 1D in accordance with one possible embodiment of the present invention, is shown. The FDOCT system 1D of FIG. 1D corresponds to a fiberized version of a Michelson interferometer setup 130 used for polarization sensitive measurements. The FDOCT system 1D illustrated in FIG. 1D is a setup in close resemblance to the former embodiment shown in FIG. 1C.

The light beam exiting from the source 1 is injected into a fiberized imaging Michelson interferometer setup 130. All or a part of the elements in this interferometer setup 130 are preferably selected from the group of polarization maintaining components, which are preferably chosen from the group of fiberized components but may be chosen also from the group of bulk-optic elements.

Frequency shifting means 3b and 3b′ are placed in the reference 131 and the sample arm 132. The Michelson interferometer setup 130 contains fiberized components for manipulating the polarization 13, 13′ in the reference 131 and sample arm 132.

At the interferometer output port the light beam is divided into two beam with orthogonal polarization by a polarization sensitive beam splitter 2d. The beams are spectrally resolved and the light spectra are detected in the spectrometer unit 7a and 7a*. A synchronization unit 8* assures the synchronization between the frequency-shifting means 3b and 3b′, the scanning optics 16 and the clock circuits of the detector in the spectrometer units 7a and 7a*. The digitized spectra at the output port of the spectrometer units 7a and 7a* are transferred to the CPU 15.

As the extinction ration of the polarisation sensitive beam dividing device 2d is often not high enough, additional components for manipulating the polarization 14 and 14* are optionally placed before the spectrometer units 7a and 7a*.

Preferably, the interferometer is built from polarization-maintaining fibers (PMF), although previous work in polarization-sensitive OCT has shown that non-PMF fiber is also capable of maintaining phase relationships between orthogonal polarization states propagating through the fiber.

For elements not mentioned explicitly nor described in this embodiment description, please refer to previous embodiment descriptions.

### II. Embodiments of Mach-Zehnder Interferometer Type

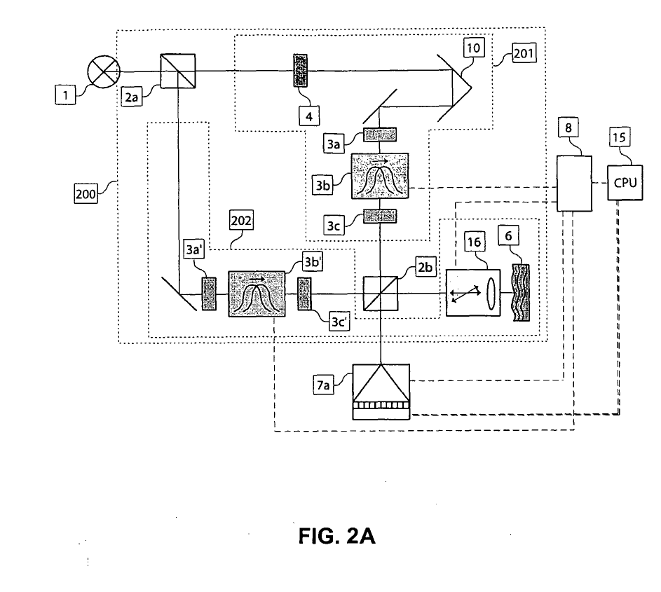

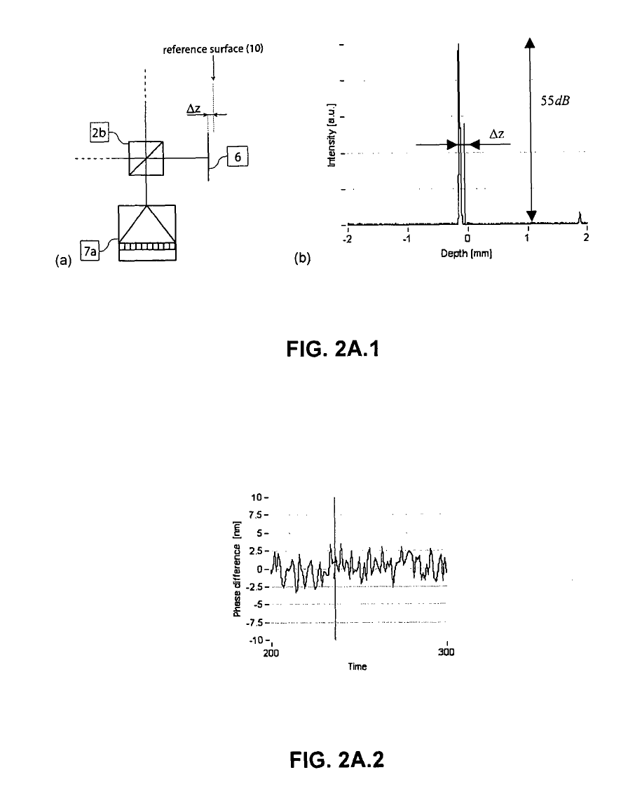

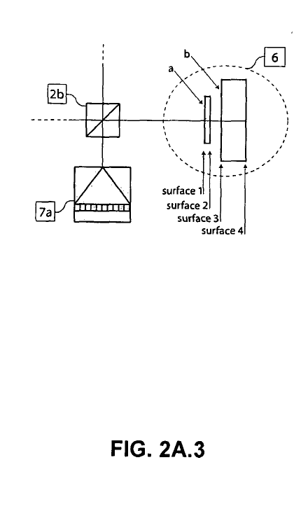

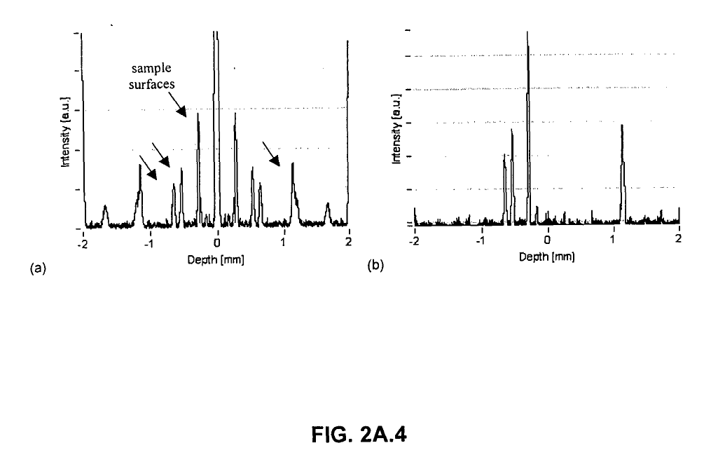

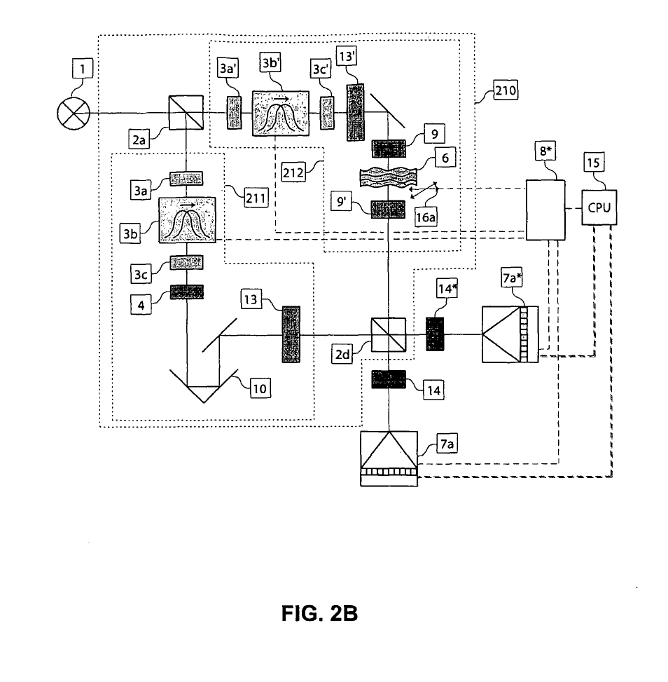

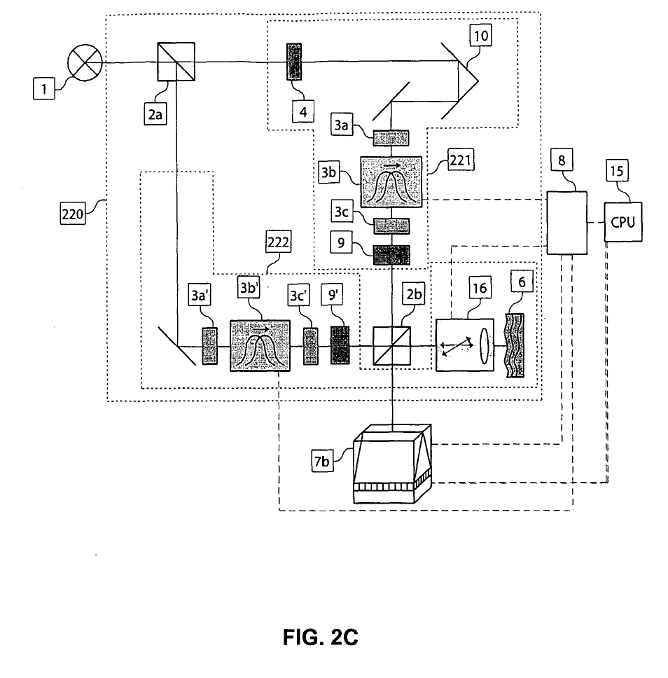

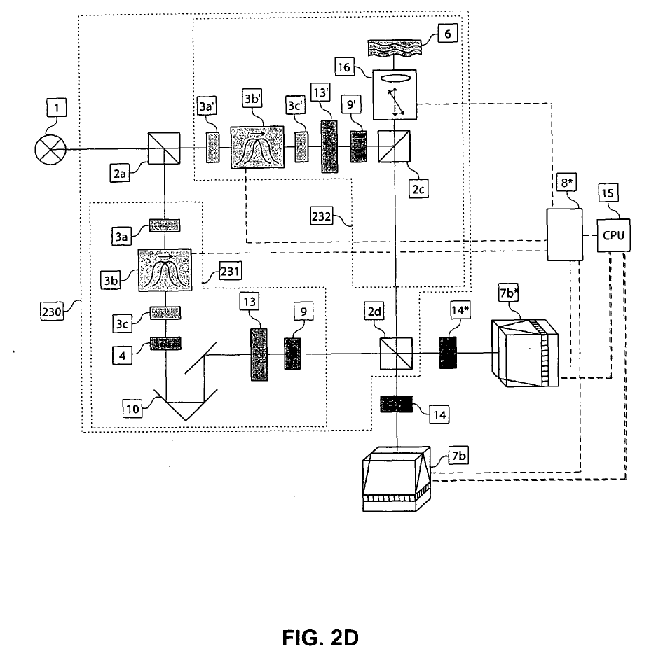

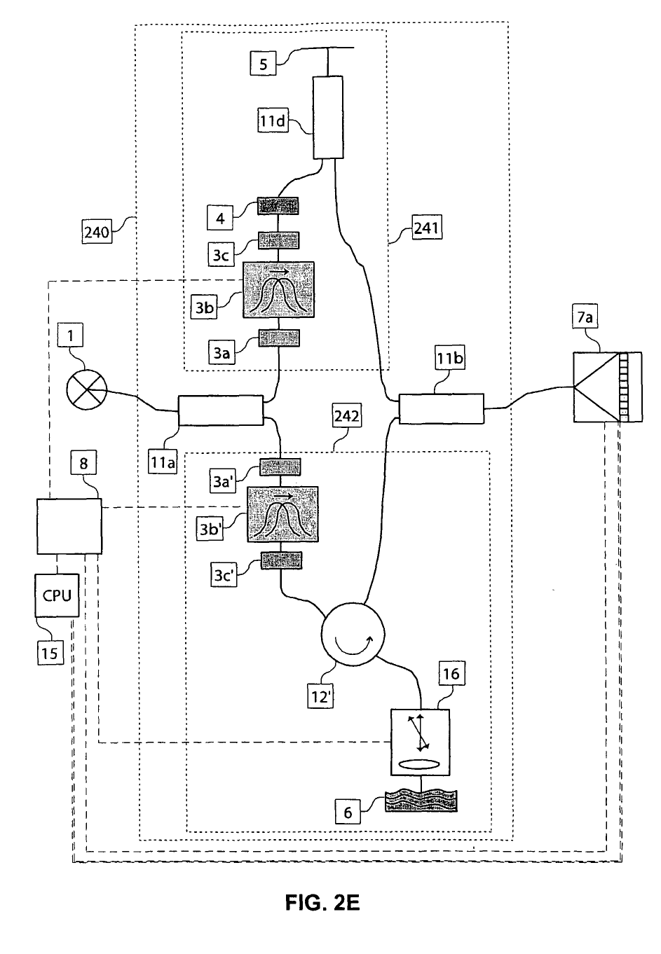

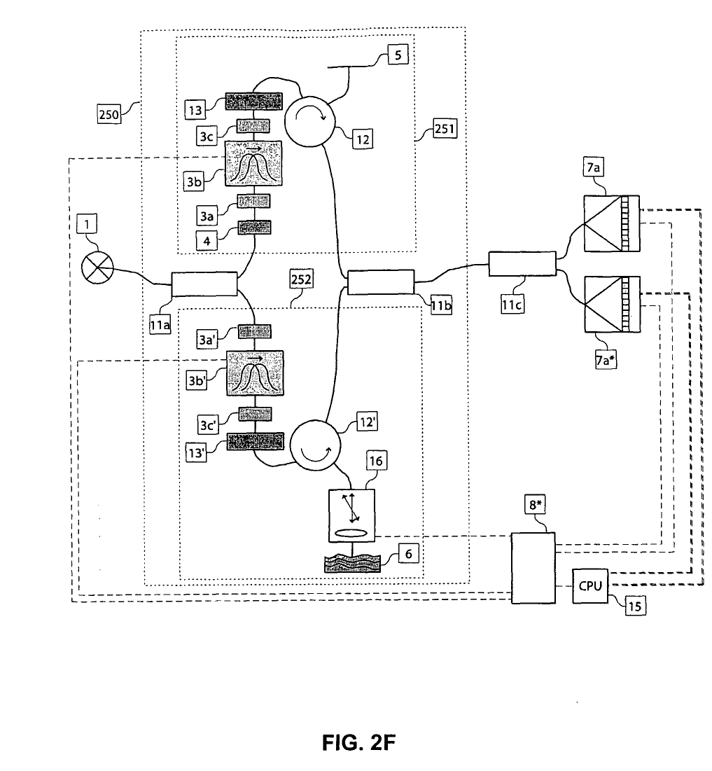

Referring to FIG. 2A, a fourth phase sensitive FDOCT system 2A in accordance with one possible embodiment of the present invention, is shown. The FDOCT system 2A of FIG. 2A corresponds to a Mach-Zehnder like, bulk optics imaging interferometer setup 200 illuminated by a partially coherent broadband source 1.

The light beam exiting from the source 1 encounters a beam dividing and recombining device 2a, which splits and redirects the light field into a reference 201 and a sample arm 202. The reference arm 201 has a pre-chosen but fixed arm-length. The optionally optical means 10 in the reference arm 201 allow adjusting the arm length difference between the arm length of the reference arm 201 and the sample arm 202. The optional optical means 10 in the reference arm 201 allow adjusting the arm length difference between the arm lengths of the reference arm 201 and the sample arm 202. However, the respective arm lengths will be fixed during measurements.

The reference arm 201 contains a frequency shifting mean 3b combined with optional, appropriately chosen compensation optics 3a and 3c, preferably placed in front and after the frequency shifting mean 3b, for optionally correcting undesired light field deviations or deformations caused by the frequency shifting mean 3b. A dispersion compensation mean 4 is placed somewhere in the reference arm 201.

The sample 6 is scanned via a scanning optics 16, which is placed in front of the sample 6. A frequency shifting mean 3b′ combined with optionally, appropriately chosen compensation optics 3a′ and 3c′, preferably placed in front and after the frequency shifting mean 3b′, is positioned in the sample arm 202 to provide an appropriate frequency shift of the sample light beam. The beam dividing and recombining device 2b recombines the back-reflected light fields from the sample arm 202 and transmitted through the reference arm 201.

The recombined light field propagates to the spectrometer unit 7a. The recorded signal is data processed within or outside the spectrometer unit 7a. A synchronization unit 8 assures the synchronization between the frequency shifting means 3b and 3b′, the scanning optics 16 and the clock circuits of the detector in the spectrometer unit 7a. This synchronization unit 8 communicates also synchronization signal to the CPU 15.

Those of ordinary skill in the art will recognize by a simple tracing of the optical paths that in a Michelson like interferometer like the interferometers 100, 110, 120 and 130 frequency shifting means 3b, 3b′ are crossed two-times in forward-backward propagation, whereas in a Mach-Zehnder like interferometer like the interferometers 200, 210, 220, 230, 240 and 250 the light beam is only once crossing the frequency shifting means 3b, 3b′. This can be of interest for the resulting frequency shifts of the light fields, due to a single or double frequency shift.

It is evident that due to the orientation of the second beam dividing and recombining device 2b the object 6 is illuminated only by one of the two light fields.

### Experimental Setup

A Mach-Zehnder like interferometer setup corresponding to the preferred embodiment 2A was built. The detector of the spectrometer 7a is a 12 bit line scan CCD with 2048 pixels, working at 20 kHz. The two frequency shifting means 3b and 3b′ were realized by two acousto-optic frequency shifters (AOFS) operating at 110 and 110.005 MHz (ω_{R}=2π·110.005 MHz±1 Hz and ω_{S}=2π·110 MHz±1 Hz). The beating signal at the detector of the spectrometer 7a therefore was 5 kHz. This detector is triggered by the synchronization unit 8 to record four images within the full period of the beating signal.

The spectrometer 7a is equipped with a reflection grating of 1200 lines/mm. The camera lens is a 135 mm objective and the above mentioned line scan CCD. The full spectral width covered by the spectrometer 7a is Δλ_{Spec}=177 nm. The source 1 is a super luminescence diode with central wavelength at λ₀=833 nm and a spectral full width at half maximum of Δλ=14 nm. The power on the sample 6 was 1 mW.

Those of ordinary skills in the art will recognize that the herewith described experimental setup is one possible solution but is not limited to that.

### System Performance

The investigated performance parameters are depth resolution, system sensitivity and phase stability. These parameters are determined by using a reflector as sample together with a calibrated neutral density filter for the sensitivity measurement.

FIG. 2A.1 illustrates: (a) The arm length difference Δz between reference arm 201 and sample arm 202. (b) Signal of reflector surface, placed at a distance Δz from the reference.-The measured SNR is 55 dB.

The depth profile after taking the absolute value of the Fourier transform of the recorded spectrum is displayed in FIG. 2A.1(b). It demonstrates the suppression of the DC component, as well as the depth range enhancement due to a removal of mirrored sample (6) signals.

The z-axis resolution δz is related to the spectrometer 7a parameters via

$$δ z = \frac{1}{2 N} \frac{{λ}_{0}^{2}}{Δ {λ}_{Spec}} ,$$

where N is the number of detector pixel and Δλ_{Spec} is the full spectral width covered by the spectrometer 7a. With a spectral width of Δλ_{Spec}=177 nm, the resolution is δz=11.5 μm. The signal corresponds to the envelope of the coherence function of the source 1, resulting in an axial resolution of δz=23 μm. The axial resolution is determined by measuring the full width half maximum of the signal peak in FIG. 2A.1(b). The position of the peak corresponds to the relative path length difference between sample 202 and reference arm 201.

As will be appreciated by those skilled in the art, sensitivity of an FDOCT system is equal to the smallest detectable sample reflectivity resulting in a signal-to-noise ratio (SNR) of 1. The signal in FIG. 2A.1(b) was obtained putting a neutral density filter of 1.8 OD in the sample arm 202 between the beam splitting and recombining mean 2b and the scanning optics 16. The SNR is determined by taking the ration of the peak value and the noise average in FIG. 2A.1(b). The sensitivity S is obtained by accounting for the filter attenuation α as S[dB]=SNR[dB]+20α[OD]. In the present case with a power of 1 mW at the sample 6, and an exposure time of 35 μs the sensitivity was S[dB]=55+20·1.8=91 dB. Shot noise limited detection is reached by adjusting the reference arm 201 signal power close to the saturation level of the spectrometer (7a) line detector by means of a neutral density filter.

FIG. 2A.2 illustrates: Phase stability: The phase at the signal peak position was extracted and the difference between two recordings delayed by one period of the beating frequency was continuously displayed: σ≦0.7°[DEG].

The signal phase is extracted by the Fourier transform according to the description in [0027]. With the two AOFS (3b and 3b′) driven at 110 and 110.005 MHz (ω_{R}=2π·110.005 MHz±1 Hz and ω_{S}=2π·110 MHz±1 Hz) the resulting beating frequency is 5 kHz. Within one period the signal is acquired four times over equal integration times (integrated bucked mode [1]) After four measurements the “initial” state is reached again (modulo 2π).

The phase stability over time is determined by calculating the phase difference between two signals with a time delay of exactly one period of the beating frequency. The result is displayed in FIG. 2A.2. The standard deviation σ of this difference over time is a measure for phase stability. In the present case σ≦0.7°[DEG] corresponds to σ≦1.6 nm at λ₀=833 nm. This demonstrates the high phase accuracy of the system.

### Measurement Test Sample

FIG. 2A.3 illustrates: A Sample with 4 surfaces. (a) is a microscopy cover slide with 80 □m±3 □m and (b) is a microscopy substrate holder plate with 950 □m±3 □m thickness. Both glass plates consist of BK7 glass with a refractive index of n=1.51.

A test target used as sample 6 with four well defined surfaces was placed in the sample arm. It consists of two stacked glass plates with an air gap in between (see FIG. 2A.3).

FIG. 2A.4 illustrates: (a) shows the structure after applying a Fourier transform to the recorded spectrum. DC is present, no complex signal and therefore the structure is mirrored and has ambiguities, resulting in only half the depth range of the complex method. (b) shows the structure after applying the algorithm described in [0026].

The reference arm length (of 201) was adjusted (by 10) prior to the measurement to a position within the sample structure. FIG. 2A.4(a) shows the depth profile, if only the Fourier transform of a single recorded spectrum is calculated. In this case the presence of DC, autocorrelation and mirror terms obscures the true structure of the sample 6. The reconstructed depth profile using the complex algorithm of [0026] is shown in FIG. 2A.4(b). The corresponding glass plate thicknesses (values corrected for n=1.51) are measured to be 77 μm and 937 μm respectively. This is in good agreement with the independently measured (mechanically measured by a micrometer screw) thickness of the glass plates.

The measurements shown in the preceding paragraphs are given as an illustrative example. They will in no case be a limit neither in resolution or measurement precision, nor a limitation in the field of application. The example was deliberately chosen to demonstrate the background and potential of our invention and it is not limited to this particular realisation. Those skilled in the art will find easily variants of this instrument which are however fully covered by our descriptions, illustrations, embodiments or claims.

Referring to FIG. 2B, a fifth phase sensitive FDOCT system 2B in accordance with one possible embodiment of the present invention, is shown. The FDOCT system 2B of FIG. 2B corresponds to a Mach-Zehnder like, bulk optics imaging interferometer setup 210 illuminated by a partially coherent broadband source 1 in a certain resemblance to the embodiment shown in FIG. 2A.

The light beam exiting from the source 1 encounters a beam dividing and recombining device 2a, which splits and redirects the light field into a reference 211 and a sample arm 212. The light beams cross frequency shifting means 3b and 3b′ combined with optional, appropriately chosen compensation optics 3a, 3a′, 3c and 3c′ and components for manipulating the polarization 13 and 13′. A dispersion compensation mean 4 is placed somewhere in the reference arm 211.

As a particularity of this FDOCT system 2B, shown in FIG. 2B and different to all other embodiments and illustrations shown, the sample 6 is investigated in transmission. In such a case it would be preferable to place the sample 6 on a movable sample holder 16a for sample scanning instead of beam scanning.

Those of ordinary skills in the art will recognize that the configuration as described by the FDOCT system 2B does not give access to the depth profile, but allows measuring for example changes in optical path length, absorption or changes in the polarisation state along the optical path.

Measuring changes in optical path length can be used for a determination of dispersion, small refractive index changes as well as changes in geometrical path length, but not limited to these examples.

At the interferometer output port the light beam is divided into two beams with preferably orthogonal polarization states by a polarization sensitive beam splitter 2d. The beams are spectrally resolved and the light spectra are detected in the spectrometer units 7a and 7a*, where (*) in 7a* denotes a preferably orthogonal polarisation state with respect to 7a. A synchronization unit 8* assures the synchronization between the frequency shifting means 3b and 3b′ and the clock circuits of the detector in the spectrometer unit 7a and 7a*, as well as the scanning optics 16. The digitized spectra at the output port of the spectrometer unit 7a and 7a* are transferred to the CPU 15.

However, it should be appreciated by those skilled in the art that there is a manifold set of solutions concerning polarization sensitive measurement and therefore the configuration showed in the FDOCT system 2B is only one possible to configuration but not limited to this shown configuration. As an example, instead of using two spectrometer units separately, a single imaging spectrometer having a multiple-stripe or two-dimensional detector array could be used.

For elements not mentioned explicitly nor described in this embodiment description, please refer to previous embodiment descriptions.

Referring to FIG. 2C, a sixth phase sensitive FDOCT system 2C in accordance with one possible embodiment of the present invention, is shown. The FDOCT system 2C of FIG. 2C corresponds to a Mach-Zehnder like, bulk optics imaging interferometer setup 220 illuminated by a partially coherent broadband source 1 in close resemblance to the embodiment shown in FIG. 2A.

The light field emitted by the source 1 is split and redirected by means of a beam dividing and recombining device 2a into a reference 221 and a sample arm 222. The light beam crosses frequency shifting means 3b and 3b′ combined with optional, appropriately chosen compensation optics 3a, 3a′, 3c and 3c′ preferably placed directly behind the frequency shifting means 3b and 3b′, each of these elements placed in the reference 221 and sample arm 222 respectively. A dispersion compensation mean 4 is placed somewhere in the reference arm 221.

The sample 6 is scanned by the scanning optics 16. The beam dividing and recombining device 2b recombines the light fields back reflected from the sample arm 222 and transmitted through the reference arm 221. The recombined light field propagate to the 2-dimensional spectrometer unit 7b for spectral decomposition and recording. The recorded signal is data processed within or outside the spectrometer unit 7b. A synchronization unit 8 assures the synchronization between the frequency shifting mean 3b and 3b′, the scanning optics 16 and the clock circuits of the detector in the spectrometer unit 7b. This synchronization unit 8 communicates also synchronization signal to the central processing unit (CPU) 15.

Beam shaping optics 9 and 9′, preferably placed before the beam dividing and recombining device 2b, is used for shaping the circular beam into a line beam for proper line illumination allowing 2-dimensional imaging.

For the realization of a line illumination many alternatives, modifications and variations will be apparent to those skilled in the art. A very basic approach is based on cylindrical lenses or an appropriately designed anamorphotic optical scheme. These given examples are in no case limiting our claims. The inventors are well aware about the rich literature and proposed solutions for line illumination.

For elements not mentioned explicitly nor described in this embodiment description, please refer to previous embodiment descriptions.

Referring to FIG. 2D, a seventh phase sensitive FDOCT system 2D in accordance with one possible embodiment of the present invention, is shown. The FDOCT system 2D of FIG. 2D corresponds to a Mach-Zehnder like, bulk optics imaging interferometer setup 230 illuminated by a partially coherent broadband source 1 in close resemblance to the embodiments shown in FIGS. 2B and 2C respectively.

The light beam exiting from the source 1 encounters a beam dividing and recombining device 2a, which splits and redirects the light field into a reference 231 and a sample arm 232. The light beam crosses the frequency shifting means 3b and 3b′, each of these elements is placed in the reference 231 or sample arm 232 respectively. A dispersion compensation mean 4 is placed somewhere in the reference arm 231. The optional optical means 10 in the reference arm 231 allow adjusting the arm length difference between the arm lengths of the reference arm 231 and the sample arm 232.

The light beam crosses components for manipulating the polarization 13 and 13′, where 13 and 13′ are preferably placed right before the beam shaping optics 9 and 9′, in order to define a specific polarisation state illuminating the sample 6. The back reflected light then propagates through the beam dividing and recombining device 2c to the interferometer output port formed preferably by a polarization sensitive beam splitter 2d.

At the interferometer output port the light beam is divided into two beams with preferably orthogonal polarization states by a polarization sensitive beam splitter 2d. The beams are spectrally resolved and the preferably orthogonal light spectra are detected in the spectrometer units 7b and 7b*. A synchronization unit 8* assures the synchronization between the frequency shifting means 3b and 3b′ and the clock circuits of the detector in the spectrometer unit 7b and 7b*, as well as the scanning optics 16. The digitized spectra analysed by the 2-dimensional spectrometer units 7b and 7b* are transferred to the CPU 15. In accordance to the FDOCT system 2B and for the same reasons, additional components for manipulating the polarization 14 and 14* are optionally placed before the spectrometer units 7b and 7b*.

For elements not mentioned explicitly nor described in this embodiment description, please refer to previous embodiment descriptions.

Referring to FIG. 2E, an eighth phase sensitive FDOCT system 2E in accordance with one possible embodiment of the present invention, is shown. The FDOCT system 2E of FIG. 2E corresponds to a fiberized version of a Mach-Zehnder like imaging interferometer setup 240 illuminated by a partially coherent broadband source 1 in close resemblance to the fourth embodiment shown in FIG. 2A.

The light beam exiting from the source 1 is injected into a fiberized Mach-Zehnder interferometer setup 240. All or a part of the elements in this setup 240 are selected from the group of fiberized components.

The fiberized beam splitting device 11a splits the light field into a reference 241 and sample arm 242. Both interferometer arms 241 and 242 contain frequency shifting means 3b and 3b′. The reference arm 241 may optionally include a dispersion compensation mean 4, which can be optionally realized by bulk optic elements. The back reflecting element 5 can be realized via a bulk optic reflector with appropriate means for in- and out-coupling into the fiber or it can be integrated in a fiber-optical element.

As it will be evident for those skilled in the art, signal loss of back reflected light from the sample 6 should be minimized. Therefore a circulator 12′ is preferably used in the sample arm 242, to direct the light via a scanning optics 16 towards the sample 6 and to further redirect the light via beam recombining device 11b to the spectrometer unit 7a. As energy loss of about 3 dB in the reference arm 241 is of less importance, the path length adapter is shown as a fiber coupler 11d and a back reflecting element 5 for adjusting the path length difference between the reference 241 and sample arm 242.

Those of ordinary skills in the art will recognize that this path length adaptation can be realized with a circulator as shown by element 12′ combined with a back reflecting element 5 or by a fiberized path length adaptation as known by those skilled in the art.

The beam recombining device 11b directs the light to the spectrometer unit 7a. The recorded signal is then data processed within or outside the spectrometer unit 7a. A synchronization unit 8 assures the synchronization between the frequency shifting means 3b and 3b′, the scanning optics 16 and the clock circuits of the detector in the spectrometer unit 7a. This synchronization unit 8 communicates also synchronization signal to the CPU 15.

For elements not mentioned explicitly nor described in this embodiment description, please refer to previous embodiment descriptions.

Referring to FIG. 2F, a ninth phase sensitive FDOCT system 2F in accordance with one possible embodiment of the present invention, is shown. The FDOCT system 2F of FIG. 2F corresponds to a fiberized and polarization sensitive version of a Mach-Zehnder like imaging interferometer setup 250 illuminated by a partially coherent broadband source 1 in close resemblance to the eighth embodiment shown in FIG. 2E.

The light beam exiting from the source 1 is injected into a fiberized Mach-Zehnder interferometer setup 250. All or a part of the elements in this setup 250 are selected from the group of fiberized and preferably polarization maintaining components.

The fiberized beam splitting device 11a splits the light field into a reference 251 and sample arm 252. Both interferometer arms 251 and 252 are equipped with frequency shifting means 3b and 3b′. The reference 251 and sample arm 252 include optionally a dispersion compensation mean 4, which can be optionally realized by bulk optic elements. The back reflecting element 5 can be realized via a bulk optic reflector with appropriate means for in- and out-coupling into the fiber or it can be integrated in a fiberized element.

A circulator 12′ is preferably used to direct the light from the frequency shifting mean 3b′ in the sample arm 252, via the scanning optics 16 to the sample 6 and back to the beam recombining device 11b.

In contrast to embodiment 2D, the FDOCT system 250 uses an optical circulator for redirecting the light field coming from the frequency shifting mean 3b via a polarization manipulating component 13, all elements placed in the sample arm 251, to the back reflecting element 5 serving as reference and further on to the beam recombining device 11b. The use of an optical circulator 12 instead of a fiber coupler as presented in embodiment 2E, allows minimizing light losses. Less signal loss will occur by redirecting the light coming from the polarization controlling element 13 to the reference surface 5 and further to the beam recombining device 11b due to the optical circulator 12.

The beam recombining device 11b, preferably polarisation maintaining, mixes the light fields coming from the reference 251 and the sample arm 252 and directs this recombined field to a third fiber coupler 11c for splitting the preferably orthogonal polarisation states and redirect the resulting two orthogonal light fields to two different spectrometer units 7a and 7a*. The recorded signals are data processed within or outside the spectrometer units 7a and 7a*.

A synchronization unit 8* assures the synchronization between the frequency shifting mean 3b and 3b′, the scanning optics 16 and the clock circuits of the detectors in the spectrometer units 7a and 7a*. This synchronization unit 8 communicates also synchronization signal to the central processing unit (CPU) 15.

For elements not mentioned explicitly nor described in this embodiment description, please refer to previous embodiment descriptions.

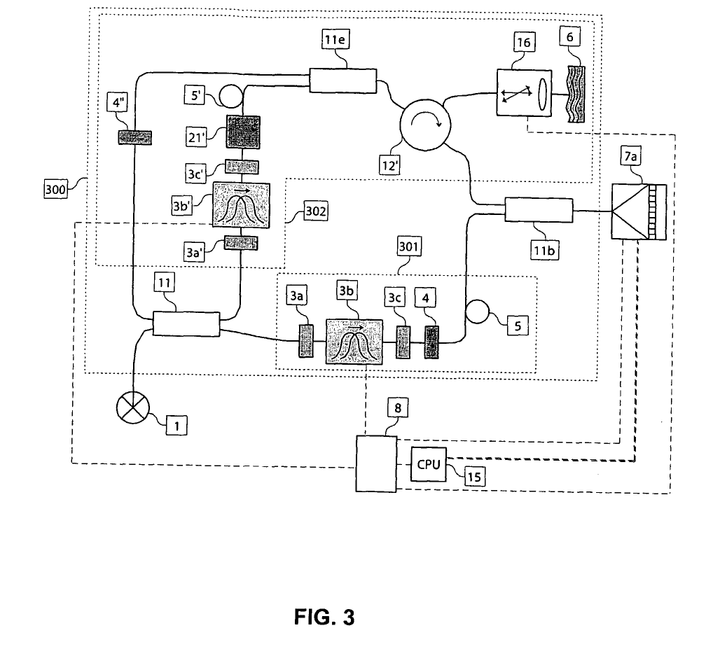

Referring to FIG. 3, a tenth phase sensitive FDOCT system 3 in accordance with one possible embodiment of the present invention, is shown. The FDOCT system 3 of FIG. 3 corresponds to a Mach-Zehnder like, fiberized interferometer setup 300 illuminated by a partially coherent broadband source 1 in close resemblance to the embodiment shown in FIG. 2E.

The light beam exiting from the source 1 is injected into a fiberized, Mach-Zehnder like interferometer setup 300. All or a part of the elements in this setup 300 are selected from the group of fiberized components.

The fiberized beam splitting and recombining device 11 splits the light field into a reference 301 and a sample arm 302. The interferometer arms 301 and 302 contain frequency shifting means 3b and 3b′, combined with optional, appropriately chosen compensation optics 3a, 3a′, 3c and 3c′.

The sample arm 302, compared to the interferometer illustrated in FIG. 2E, is different as follows: The light field coming from the beam splitting and recombining device 11 is preferably half reflected but at least partially reflected by a partially reflecting mean 21′ as well as partly transmitted across the partially reflecting mean 21′, which is positioned after the frequency shifting mean 3b′ and preferably its compensation optics 3c′. The reflected light field crosses again the compensation optics 3c′, the frequency shifting means 3b′, the compensation optics 3a′ and the beam splitting and recombining device 11, where the light is redirected to the source 1 (as lost signal) and via a dispersion compensation means 4″ to the beam recombining device 11e.

The twice shifted light field (due to the double crossing of the frequency shifting mean 3b′) is recombined at the beam recombining device 11e with the one time frequency shifted light field and redirected to a preferably used optical circulator 12′. With such modification in the sample arm 302, the sample 6 is illuminated by a superposed light field resulting in a timely varying (beat signal) illumination of the sample 6.

The optical circulator 12′ is used to direct the light arriving from the beam recombining device 11e to the scanning optics 16 and therefore to the sample 6 and back to the beam recombining device 11b, where the reference 301 and sample arm 302 are recombined and delivered to the spectrometer unit 7a. The recorded signal is then data processed within or outside the spectrometer unit 7a. A synchronization unit 8 assures the synchronization between the frequency shifting means 3b and 3b′, the scanning optics 16 and the clock circuits of the detector in the spectrometer unit 7a. This synchronization unit 8 communicates also synchronization signal to the central processing unit (CPU) 15.

Those of ordinary skills in the art will recognize that several beating frequencies result. Therefore the detection unit may be switched and synchronized to one of the several resulting beating frequencies.

The reference 301 and sample arm 302 may optionally include dispersion compensation means 4 and 4″, which can be optionally realized by bulk optic elements, and means for adjusting path lengths 5 and 5′ of the reference 301 and the sample arm 302. These path length adjusting means 5 and 5′ can be realized via a fiberized approach like fiber length stretching or in bulk optics like it was described in several other possible embodiments. It is evident to those skilled in the art that there is a manifold set of solutions for such an arm length adjusting mean 5 and 5′ and therefore the above given example shall not be understood as a limiting one.

For those skilled in the art it is evident that there is a manifold set of solutions concerning combination of interferometer types, reference or sample path modifications as multiplications of the frequency shifts by wiring differently, reflecting the electromagnetic fields etc., resulting in additional degrees of freedom for specific measurements and applications.

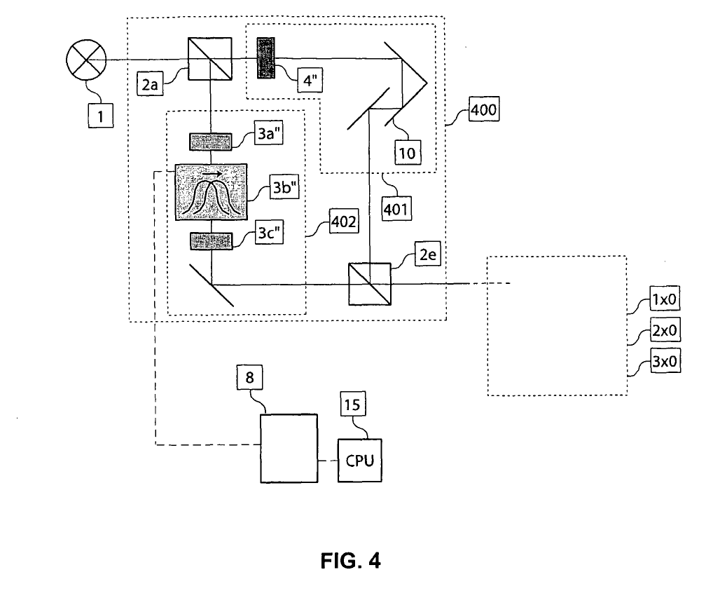

Referring to FIG. 4, a first embodiment of an “interferometric source” 400, in combination and for use with the present invention, is shown. Those of ordinary skill in the art will recognize that the illustration in FIG. 4 corresponds to a Mach-Zehnder like, bulk optics interferometer setup 400 illuminated by a partially coherent broadband source 1. Light from the broadband source 1 is divided and redirected by the beam splitting and recombining device 2a into two arms 401 and 402. The arm 401 contains an optional optical mean 4 for dispersion compensation, which can be positioned elsewhere in arm 401.

The optionally optical means 10 in arm 401 allow adjusting the arm length difference between the arm length of arm 401 and the arm 402. The arm 402 contains a frequency shifting mean 3b″ combined with optional, appropriately chosen compensation optics 3a″, 3c″ for optionally correcting undesired light field deviations or deformations caused by the frequency shifting mean 3b″.

The beam splitting and recombining device 2e recombines the light fields from arms 401 and 402 and is connected as an “interferometric source” to the input port of the imaging interferometers as shown in the illustrations FIG. 1A to 1D, FIG. 2A to 2F or FIG. 3. In this case the “interferometric source” 400 substitutes the source 1 shown in the aforementioned illustrations. The electronic synchronization unit 8 links the driving signals of the frequency shifting means 3b″ and the CPU 15 and allows to synchronize the frequency shifting means, detectors and scanners of a total set-up.

As will be appreciated by those of ordinary skill in the art, there are several ways to realize an “interferometric source”. It is evident, that such a device can also be realized partly or in total with fiberized components and elements or by another suitable interferometer type.

Those of ordinary skills in the art will recognize that a Michelson type set-up as described before in the illumination interferometers, can also be used for building this “interferometric source”. The various embodiments shown for the imaging interferometer allow deducing all necessary details for designing a Michelson type “interferometric source”. A rather natural extension of this embodiment will be an adding of additional interferometer arms each of them containing a frequency shifting mean driven with a specific frequency. This would allow switching rapidly to different beating frequencies and to access different sample properties.

As will be appreciated by those with ordinary skills in the art, the combination of an “interferometric source” together with the embodiments as shown in the illustrations FIG. 1A to 1D and FIG. 2A to 2F, where the reference arm is blocked or even removed, can be viewed as a common path interferometer, where the frequency shifting mean 3b′, together with its compensation optics 3a′ and 3c′, may be removed.

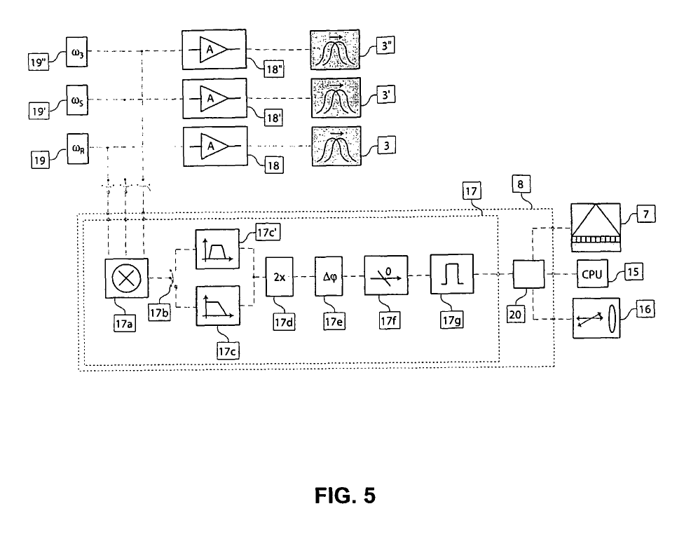

Referring to FIG. 5, one possible realization of trigger signal generation 17 as a part of a first synchronization unit 8, in combination and for use with the present invention, is shown.

At least two signal generators 19, 19′ and optionally additional signal generators 19″ are generating electric signals, preferably varying in sinusoidal manner. These signals are amplified by amplification devices 18, 18′ and 18″ and used to drive the frequency shifters placed in the FDOCT system in accordance and correspondence to the present invention.

Preferably two of these signals, in correspondence to the required trigger signal, are electronically mixed by a mixer 17a. By means of a mechanic, electronic or programmable switcher 17b, low-pass filtering 17c or band-pass filtering 17c′ are chosen allowing a best signal filtering. This signal is frequency doubled 17d (four measurement points per beating period) and preferably phase shifted via the phase shifting unit 17e. A detection of the zero crossing by 17f is followed by a for example TTL trigger signal generation 17g.

A preferably programmable unit 20 delivers the trigger signal in an appropriate manner to the respective elements, clocks, units or detectors 7, 15, 16, etc. as shown in the illustrations of our numerous preferred embodiments and their descriptions.

### DEFINITIONS

As used herein, “frequency shifting mean” means any fiberized optics, bulk device or integrated optics used to up- or down-shift the frequency of an input electromagnetic signal. This frequency shifting mean shifts all frequencies of an input electromagnetic signal, i.e. the complete spectrum of the input field, by adding or subtracting the same frequency shift to each frequency component of the input field. In other wording the whole input frequency spectrum is displaced in frequency space by this frequency shifting mean. This is normally used for a stable wavelength independent shift. But it may include also chirping, or general timely changing frequency shifts etc. but is not limited herewith.

“Source” is used to mean any source of electromagnetic radiation. The source 1 in the aforementioned embodiments is preferably a short coherent source. Multiple sources substituting the one illustrated source 1 in our preferred embodiments may also be used for increasing the intensity or extending the spectral bandwidth. The source may also be an interferometric source.

“Interferometric source” is used to mean any source that comprises an interferometer, and at least one frequency shifting mean in one of the arms. The relative optical path length between the arms may be adjustable.

The spectrometers 7, 7a, 7a* or 7b, 7b* used in the preferred embodiments should preferably be selected for maximum optical throughput and optimized especially regarding its modulation transfer function. Ideally the full spectral content of the source is imaged onto the array detector. The wavelength dividing element of the spectrometer is preferably a transmission or reflection diffraction grating, but not limited to those. Among different possible spectrometer designs, a Czerny-Turner configuration currently exhibits optimal characteristics. For parallel configurations multi dimensional detector arrays are needed. The optics of the spectrometer needs to be accordingly chosen such that the full parallel set of spectra is imaged onto the detector with a minimum loss of spectral or spatial sample information.

“Detector” is used herein to mean any device capable of measuring energy in an electromagnetic signal as a function of wavelength. A detector array means a plurality of detectors. In general the preferred detector arrays used for FDOCT imaging have their optimal sensitivity in the wavelength range of the used source. The detectors can either be one-, multi-dimensional or line arrays, depending on the optical setup and the spectrometer design. In the mostly used wavelength range around 800 nm, CCD detectors have currently the best performance with respect to sensitivity and read out speed. However, current detector technology does not provide CCD detectors that operate in the 1300 nm region. For this case photodiode arrays with InGaAs substrate are available. Alternatively for the 800 nm range, metal oxide semiconductor (CMOS) arrays become increasingly available due to a fast development of sensitive and low cost detector arrays. Also additional signal processing steps can be integrated on chip. These CMOS arrays, also known as smart pixel array detectors (SPAD), are of particular interest if the DC signal components are suppressed and the AC signal components are amplified via an AC-amplification electronics. This example of integrated signal processing is in no case limiting the claims and description for these detector elements. Current-generation CMOS arrays utilize silicon substrates and may thus be unsuitable for imaging at the popular OCT wavelengths above 1 μm.

It should be noted that the term “optical circulator” is used herein to mean any type of device capable of directional coupling of electromagnetic radiation incident on port 1 to port 2, while simultaneously coupling electromagnetic radiation incident on port 2 to port 3 of such a circulator element.

Also, as used herein, a “fiber coupler” is used to mean any device which receives an input signal of electromagnetic radiation and divides that signal between two output ports. It should be noted that as used herein, a fiber coupler may have multiple ports wherein each port can serve as an input port for a selected pair of output ports as well as function as an output port for a selected input port.

“Optical fiber” is used to mean any device or set of devices used to guide electromagnetic radiation along a prescribed path. Thus, “optical fiber” can mean a signal strand of optically transparent material bounded by a region of contrasting index of refraction, as well as mirrors or lenses used to direct electromagnetic radiation along a prescribed path.

“Reflector” is used herein to mean any device capable of reflecting an electromagnetic signal. Thus, “reflector” can be used to mean a mirror, an abrupt change in an index of refraction, an auto-reflecting prism as well as a periodically spaced array structure such as a Bragg reflector.

“Scanning optics” means any system configured to sweep an electromagnetic signal across a chosen area. Often this configuration includes optionally appropriate focusing means, appropriately positioned for performing an object-scan with either a diffraction limited focusing spot, or a plurality of spots, or with a continuous line.

Applicants note that the terms “signal”, “beam” and “light” are used in a synonymously manner, for including all forms of electromagnetic radiation suitable for use in imaging systems.

It is also understood, that for the purposes of this disclosure, the term “optical” is to pertain to all wavelength ranges of electromagnetic radiation, and preferably pertains to the range of 100 nanometers to 30 micrometers.

The foregoing embodiments and advantages are merely exemplary and are not to be construed as limiting the present invention. The present explanations can be readily applied to other types of apparatuses. The description of the present invention is intended to be illustrative and not to limit the scope of the claims. Many alternatives, modifications and variations will be apparent to those skilled in the art.

In the claims, means-plus-function clauses are intended to cover the structures described herein as performing the recited function and not only structural equivalents but also equivalent structures.

### LIST OF REFERENCES

[1] D. Malacara, “Optical Shop Testing”, 2^{nd} edition, 1992, Wiley & Sons Inc, New York
[2] B. E. A. Saleh, M. C. Teich, “Fundamentals of Photonics”, 1991, Wiley & Sons Inc. New York

1. An optical system for phase-resolved, Fourier domain optical coherence tomography, comprising
a) a source
b) an interferometer comprising optical means for splitting and recombining the different light fields, the means for splitting light fields defining an optical sample path (sample arm) providing a sample arm light with a region of illumination on the sample and an optical reference path (reference arm) providing a reference arm light,
c) at least one frequency shifting mean for generating a wavelength independent beating signal at the detector,
d) a pre-adjusted, but fixed reference arm length during the measurement,
e) a synchronization unit,
f) at least one spectrometer combined with at least one detector for recording at least one spectrum at a given time point,
g) a data processor for processing the detected optical signals and delivering a tomogram,
wherein the at least one frequency shifting mean and the at least one detector are synchronized by the synchronization unit resulting in a wavelength independent, phase-resolved measurement.

2. An optical system according to claim 1, wherein at least three frequency shifting means for generating appropriate beat frequencies
a) for measuring only the autocorrelation contribution resulting from light interactions in the reference arm,
b) for measuring only the autocorrelation contribution resulting from interactions in the sample arm including light sample interactions
c) or for measuring the cross-correlation between both arms
by an appropriate synchronisation of the clock frequency of at least one of the detectors to the specific beat frequencies.

3. An optical system according to claim 1, wherein the optical means for guiding, splitting and recombining the different light fields are selected from the group comprising “free space optical beam splitters and circulators” or are selected from the group comprising fiberoptical elements as fiberoptic 2×2 wave couplers, fiberoptic 1×2 and 2×1 wave couplers, optical circulators or combinations of free space optical elements with fiberoptical elements.

4. An optical system according to claim 1, wherein the at least one frequency shifting mean is selected from the group comprising acousto-optic frequency shifting means or mechanical frequency shifting elements.

5. An optical system according to claim 1, wherein frequency shifting means are provided in the sample and/or the reference arm.

6. An optical system according to claim 1, wherein the interferometer contains more than one reference and/or more than one sample arm and/or is combined with optionally a multitude of additional interferometers, where these interferometers may be of a different and/or a multitude of different interferometer types.

7. An optical system according to claim 1, wherein more than one frequency shifting means are provided in the same arm.

8. An optical system according to claim 1, wherein the at least one detector is selected from the group comprising line detectors, 1D or multi-dimensional array detectors.

9. An optical system according to claim 1, wherein the at least one detector is selected from the group comprising array detector with an on chip integrated signal processing electronics for measuring an oscillatory component.

10. An optical system according to claim 1, wherein the synchronization unit locks the clock frequency or a multiple of the clock frequency of the detector to the frequency difference of the frequency shifting means.

11. An optical system according to claim 1 additionally comprising a scanning unit for displacing the light fields on the sample and redirecting reflected light components back into the interferometer.

12. An optical system according to claim 11, wherein the scanning unit comprises a unit for displacing the sample in at least one dimension within the sample space.

13. An optical system according to claim 1 additionally comprising components for dispersion compensation in the reference arm and/or sample arm.

14. An optical system according to claim 1 additionally comprising polarization-sensitive optical elements and/or polarization-controlling optical elements in the sample and/or the reference arm, enabling the detection of spectra for at least two different states of polarization.

15. An optical system according to claim 14, wherein two or more spectra at different states of polarization are detected using one or more spectrometers, each equipped with at least one detector.

16. An optical system according to claim 1, wherein the detected optical signals are processed by the data processor using an algorithm from the group of Fourier-transform based algorithms for calculating the depth profile and/or deduced phase or amplitude information from the measured spectra.

17. An optical system according to claim 1, wherein a plurality of spots on the sample are illuminated simultaneously.

18. An optical system according to claim 1, wherein a region in the geometrical form of a continuous line on the sample is illuminated simultaneously.

19. An optical system according to claim 1, wherein the light field of the optical sample path is reflected from the region of illumination on the sample and detected by the at least one detector.

20. An optical system according to claim 1 wherein light of the light field of the optical sample path with a region of illumination on the sample is transmitted through the sample and detected by the at least one detector.

21. An optical system according to claim 1, wherein “the optical paths are configured as free-space optics”.

22. An optical system according to claim 1, wherein “the optical paths are configured as fiber-optical paths”.

23. An optical system according to claim 22 comprising polarization maintaining fibers and wave couplers.

24. An optical system according to claim 1, additionally comprising beam shaping optical components.

25. An optical system according to claim 1 combined with an interferometric source comprising at least one frequency shifting mean.

26. An optical system comprising a common path interferometer combined with an interferometric source comprising at least one frequency shifting mean.

27. The use of an optical system according to claim 1 for, but in no case limited to
a) polarization sensitive measurements
b) absorption measurements
c) spectroscopic property measurements
d) differential phase measurements
e) static or dynamic dispersion measurements
f) measurements of functional parameters as blood flow, tissue elasticity, tissue properties etc.
g) measurement of defect localization in transparent or semitransparent media
h) measurement of spectroscopic defect characteristics if transparent or semitransparent media
of technical and/or biological samples.
